(19) United States
(12) Patent Application Publication
(10) Pub. No.: US 2022/0048710 A1
(43) Pub. Date: Feb. 17, 2022

(54) Load Lifting Strap Assembly

(71) Applicant: Rodney Fuller, Midway, GA (US)

(72) Inventor: Rodney Fuller, Midway, GA (US)

(21) Appl. No.: 16/991,098

(22) Filed: Aug. 12, 2020

(51) Int. Cl. B65G 7/12; F16B 7/10; A44B 11/02

(52) U.S. Cl. CPC B65G 7/12; A44B 11/02; F16B 7/105

(57) ABSTRACT

A load lifting strap assembly for facilitating a pair of users to carry a heavy object includes a pair of poles that is each of the poles is positionable on opposite sides of an object to be carried by a pair of users. Each of the poles has an adjustable length to accommodate objects of various lengths. A first strap is coupled around each of the poles to support the object being carried. A second strap is coupled around each of the poles to support the object being carried. A third strap is coupled around each of the poles and the third strap can be extended over the object being carried for securing the object on the poles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lifting devices and more particularly pertains to a new lifting device for facilitating a pair of users to carry a heavy object.

### (2) Description of Related Art Including Information Disclosed Under 37 CFR 1.97 and 1.98

The prior art relates to lifting devices including a lifting device that includes a pair of poles and a flexible sheet extending between the poles for supporting an object. The prior art discloses a carrying device that includes a tray that is attached to a pair of harnesses, each being worn on a respective user, for carrying an object in the tray. The prior art also discloses a variety of lifting devices that include a pair of harnesses, each being wearable on a respective user, and a strap extending between the harnesses for lifting an object. The prior art discloses a carrying device that includes a flexible sheet that is positionable beneath a person and a plurality of straps that are extendable across the person to secure the person on the flexible sheet for carrying the person.

### BRIEF SUMMARY OF THE INVENTION

An embodiment of the disclosure meets the needs presented above by generally comprising a pair of poles that is each of the poles is positionable on opposite sides of an object to be carried by a pair of users. Each of the poles has an adjustable length to accommodate objects of various lengths. A first strap is coupled around each of the poles to support the object being carried. A second strap is coupled around each of the poles to support the object being carried. A third strap is coupled around each of the poles and the the third strap can be extended over the object being carried for securing the object on the poles.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a load lifting strap assembly according to an embodiment of the disclosure.

FIG. 2 is a perspective view of an embodiment of the disclosure showing a pair of poles being shortened.

FIG. 3 is a left side view of an embodiment of the disclosure.

FIG. 4 is a top view of an embodiment of the disclosure.

FIG. 5 is a perspective in-use view of an embodiment of the disclosure.

FIG. 6 is a front view of a carrying case of an embodiment of the disclosure.

### DETAILED DESCRIPTION OF THE INVENTION

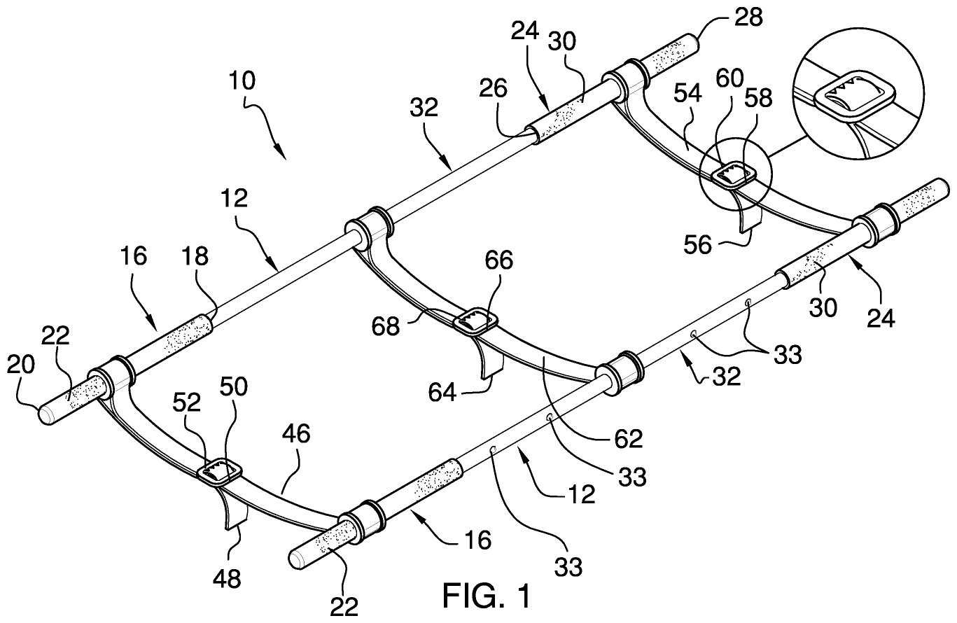

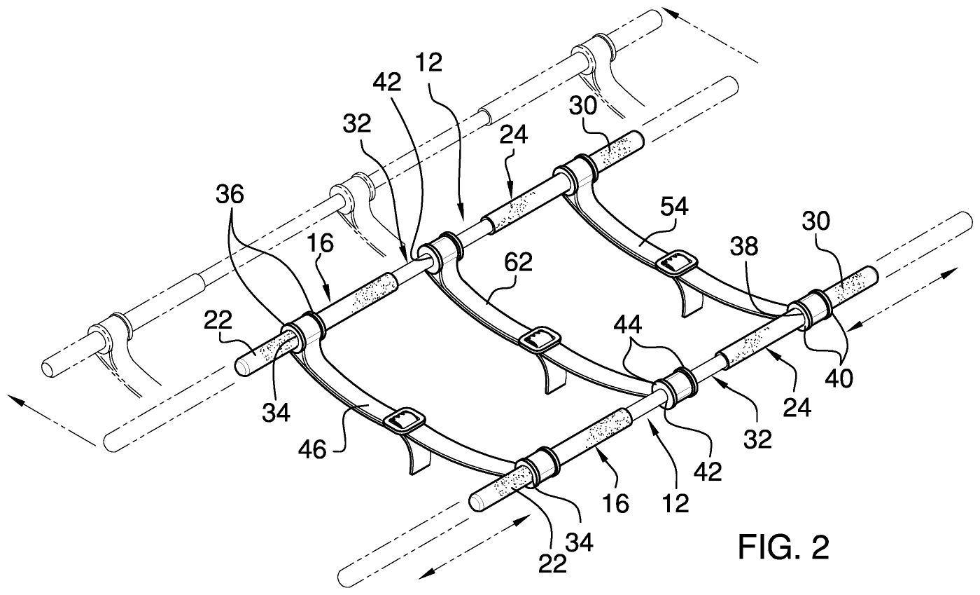

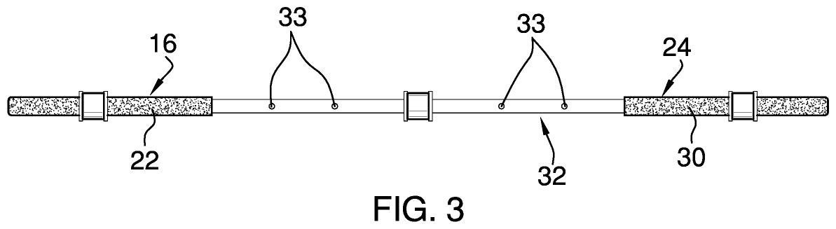

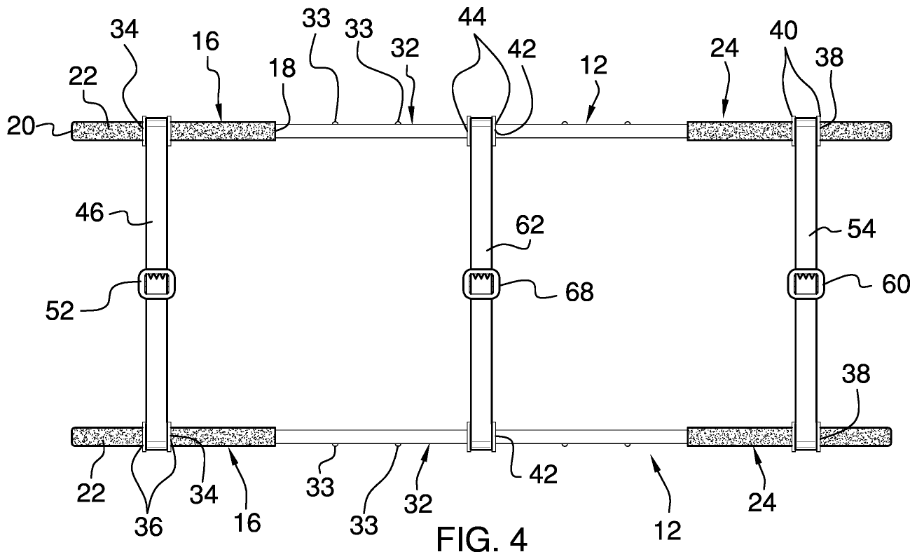

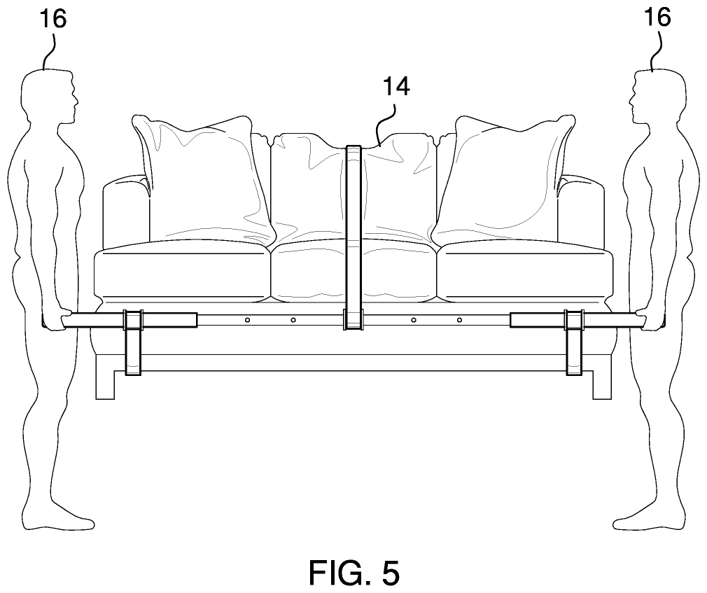

With reference now to the drawings, and in particular to FIGS. 1 through 6 thereof, a new lifting device embodying the principles and concepts of an embodiment of the disclosure and generally designated by the reference numeral 10 will be described.

As best illustrated in FIGS. 1 through 6, the load lifting strap assembly 10 generally comprises a pair of poles 12 that is each positionable on opposite sides of an object 14 to be carried by a pair of users 16. Each of the poles 12 has an adjustable length to accommodate objects 14 of various lengths. Each of the poles 12 comprises a first section 16 that has a first end 18 and a second end 20, the first end 18 is open and the first section 16 is hollow. A first grip 22 is positioned around the first section 16 and the first grip 22 is comprised of a resiliently compressible material for gripping by a respective one of the users 16.

Each of the poles 12 includes a second section 24 that has a first end 26 and a second end 28. The first end 26 of the second section 24 is open and the second section 24 is hollow. A second grip 30 is positioned around the second section 24 and the second grip 30 is comprised of a resiliently compressible material for gripping by a respective one of the users 16. Each of the poles 12 includes a third section 32 that extends into the first ends 18, 26 of each of the first section 16 and the second section 24. Each of the first section 16 and the second section 24 is slidable toward or away from each other on the third section 32 for adjusting a length of the poles 12. Additionally, the third section 32 of each of the poles 12 has a plurality of stops 33 thereon that are distributed along a full length of the third section 32. Each of the first section 16 and the second section 24 releasably engage respective stops 33 for retaining each of the poles 12 at the selected length.

A pair of first sleeves 34 is provided and the first section 16 of each of the poles 12 extends through a respective one of the first sleeves 34. Each of the first sleeves 34 has a pair of ridges 36 thereon, each of the ridges 36 on a respective one of the first sleeves 34 extends around a full circumference of the respective first sleeve 34 and the ridges 36 on the respective first sleeve 34 are spaced apart from each other. A pair of second sleeves 38 is provided and the second section 24 of each of the poles 12 extends through a respective one of the second sleeves 38. Each of the second sleeves 38 has a pair of ridges 40 thereon, each of the ridges 40 on a respective one of the second sleeves 38 extends around a full circumference of the respective second sleeve 38 and the ridges 40 on the respective second sleeve 38 are spaced apart from each other. A pair of third sleeves 42 is provided and the third section 32 of a respective one of the poles 12 extends through a respective one of the third sleeves 42. Each of the third sleeves 42 has a pair of ridges 44 thereon, each of the ridges 44 on a respective one of the third sleeves 42 extends around a full circumference of the respective third sleeve 42 and the ridges 44 on the respective third sleeve 42 are spaced apart from each other.

A first strap 46 is coupled around each of the poles 12 to support the object 14 being carried. The first strap 46 extends around each of the first sleeves 34 and the ridges 36 on each of the first sleeves 34 inhibit the first strap 46 from sliding off of the first sleeves 34. The first strap 46 has a primary end 48 and a secondary end 50, and a first buckle 52 is coupled to the secondary end 50 of the first strap 46. The primary end 48 of the first strap 46 is extendable through the first buckle 52 for adjusting a length of the first strap 46.

A second strap 54 is coupled around each of the poles 12 to support the object 14 being carried. The second strap 54 extends around each of the second sleeves 38 and the ridges 40 on each of the second sleeves 38 inhibit the second strap 54 from sliding off of the second sleeves 38. The second strap 54 has a primary end 56 and a secondary end 58, and a second buckle 60 is coupled to the secondary end 58 of the second strap 54. The primary end 56 of the second strap 54 is extendable through the second buckle 60 for adjusting a length of the second strap 54.

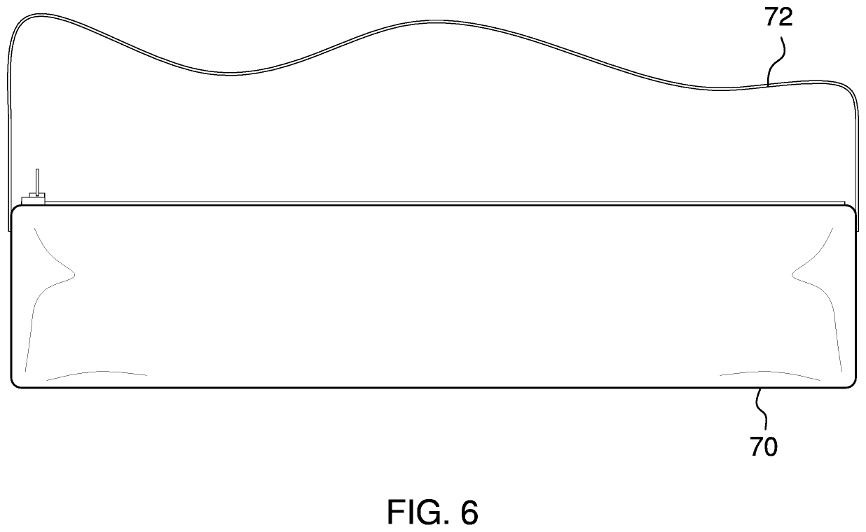

A third strap 62 is coupled around each of the poles 12 and the third strap 62 can be extended over the object 14 being carried for securing the object 14 on the poles 12. The third strap 62 extends around each of the third sleeves 42 and the ridges 44 on each of the third sleeves 42 inhibit the third strap 62 from sliding off of the third sleeves 42. The third strap 62 has a primary end 64 and a secondary end 66, and a third buckle 68 is coupled to the secondary end 66 of the third strap 62. The primary end 64 of the third strap 62 is extendable through the third buckle 68 for adjusting a length of the third strap 62. As is most clearly shown in FIG. 6, a carrying bag 70 is provided and a strap 72 may be coupled to the carrying bag 70 to carry the carrying bag 70. Each of the poles 12, the first strap 46, the second strap 54 and the third strap 62 can be carried in the carrying bag 70.

In use, each of the poles 12 is adjusted to the desired length and the object 14 is placed between the poles 12 such that the object 14 lies on the first strap 46 and the second strap 54. The third strap 62 is extended over the object 14 and the third strap 62 is tightened in the third buckle 68 to secure the object 14. Each of the users 16 grabs respective first sections 16 and second sections 24 of the pair of poles 12 and each of the users 16 lifts the poles 12 upwardly. In this way the object 14 can be lifted and carried in a secure manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A load lifting strap assembly to facilitate a pair of users to safely lift and carry a heavy object, said assembly comprising:
a pair of poles, each of said poles being positionable on opposite sides of an object to be carried by a pair of users, each of said poles having an adjustable length wherein said pair of poles is configured to accommodate objects of various lengths;
a first strap being coupled around each of said poles wherein said first strap is configured to support the object being carried;
a second strap being coupled around each of said poles wherein said second strap is configured to support the object being carried; and
a third strap being coupled around each of said poles wherein said third strap is configured to be extended over the object being carried for securing the object on the poles.

2. The assembly according to claim 1, wherein each of said poles comprises a first section having a first end and a second end, said first end being open, said first section being hollow.

3. The assembly according to claim 2, wherein each of said poles comprises a first grip being positioned around said first section, said first grip being comprised of a resiliently compressible material wherein said first grip is configured to be gripped by a user.

4. The assembly according to claim 3, wherein each of said poles includes a second section having a first end and a second end, said first end of said second section being open, said second section being hollow.

5. The assembly according to claim 4, wherein each of said poles includes a second grip being positioned around said second section, said second grip being comprised of a resiliently compressible material wherein said second grip is configured to be gripped by a user.

6. The assembly according to claim 4, wherein each of said poles includes a third section extending into said first end of each of said first section and said second section, each of said first section and said second section being slidable toward or away from each other on said third section for adjusting a length of said poles.

7. The assembly according to claim 2, further comprising a pair of first sleeves, each of said first sleeves having said first section of a respective one of said poles extending therethrough, each of said first sleeves having a pair of ridges thereon, each of said ridges on a respective one of said first sleeves extending around a full circumference of said respective first sleeve, said ridges on said respective first sleeve being spaced apart from each other.

8. The assembly according to claim 4, further comprising:
a pair of first sleeves; and
a pair of second sleeves, each of said second sleeves having said second section of a respective one of said poles extending therethrough, each of said second sleeves having a pair of ridges thereon, each of said ridges on a respective one of said second sleeves extending around a full circumference of said respective second sleeve, said ridges on said respective second sleeve being spaced apart from each other.

9. The assembly according to claim 6, further comprising:
a pair of first sleeves;
a pair of second sleeves; and
a pair of third sleeves, each of said third sleeves having said third section of a respective one of said poles extending therethrough, each of said third sleeves having a pair of ridges thereon, each of said ridges on a respective one of said third sleeves extending around a full circumference of said respective third sleeve, said ridges on said respective third sleeve being spaced apart from each other.

10. The assembly according to claim 7, wherein said first strap extends around each of said first sleeves, said ridges on each of said first sleeves inhibiting said first strap from sliding off of said first sleeves, said first strap having a primary end and a secondary end.

11. The assembly according to claim 10, further comprising a first buckle being coupled to said secondary end of said first strap, said primary end of said first strap being extendable through said first buckle for adjusting a length of said first strap.

12. The assembly according to claim 8, wherein said second strap extends around each of said second sleeves, said ridges on each of said second sleeves inhibiting said second strap from sliding off of said second sleeves, said second strap having a primary end and a secondary end.

13. The assembly according to claim 12, further comprising:
a first buckle; and
a second buckle being coupled to said secondary end of said second strap, said primary end of said second strap being extendable through said second buckle for adjusting a length of said first strap.

14. The assembly according to claim 9, wherein said third strap extends around each of said third sleeves, said ridges on each of said third sleeves inhibiting said third strap from sliding off of said third sleeves, said third strap having a primary end and a secondary end.

15. The assembly according to claim 14, further comprising:
a first buckle;
a second buckle; and
a third buckle being coupled to said secondary end of said third strap, said primary end of said third strap being extendable through said third buckle for adjusting a length of said first strap.

16. A load lifting strap assembly to facilitate a pair of users to safely lift and carry a heavy object, said assembly comprising:
a pair of poles, each of said poles being positionable on opposite sides of an object to be carried by a pair of users, each of said poles having an adjustable length wherein said pair of poles is configured to accommodate objects a various lengths, each of said poles comprising;
a first section having a first end and a second end, said first end being open, said first section being hollow;
a first grip being positioned around said first section, said first grip being comprised of a resiliently compressible material wherein said first grip is configured to be gripped by a user;
a second section having a first end and a second end, said first end of said second section being open, said second section being hollow;
a second grip being positioned around said second section, said second grip being comprised of a resiliently compressible material wherein said second grip is configured to be gripped by a user; and
a third section extending into said first end of each of said first section and said second section, each of said first section and said second section being slidable toward or away from each other on said third section for adjusting a length of said poles;
a pair of first sleeves, each of said first sleeves having said first section of a respective one of said poles extending therethrough, each of said first sleeves having a pair of ridges thereon, each of said ridges on a respective one of said first sleeves extending around a full circumference of said respective first sleeve, said ridges on said respective first sleeve being spaced apart from each other;
a pair of second sleeves, each of said second sleeves having said second section of a respective one of said poles extending therethrough, each of said second sleeves having a pair of ridges thereon, each of said ridges on a respective one of said second sleeves extending around a full circumference of said respective second sleeve, said ridges on said respective second sleeve being spaced apart from each other;
a pair of third sleeves, each of said third sleeves having said third section of a respective one of said poles extending therethrough, each of said third sleeves having a pair of ridges thereon, each of said ridges on a respective one of said third sleeves extending around a full circumference of said respective third sleeve, said ridges on said respective third sleeve being spaced apart from each other;
a first strap being coupled around each of said poles wherein said first strap is configured to support the object being carried, said first strap extending around each of said first sleeves, said ridges on each of said first sleeves inhibiting said first strap from sliding off of said first sleeves, said first strap having a primary end and a secondary end;
a first buckle being coupled to said secondary end of said first strap, said primary end of said first strap being extendable through said first buckle for adjusting a length of said first strap;
a second strap being coupled around each of said poles wherein said second strap is configured to support the object being carried, said second strap extending around each of said second sleeves, said ridges on each of said second sleeves inhibiting said second strap from sliding off of said second sleeves, said second strap having a primary end and a secondary end;
a second buckle being coupled to said secondary end of said second strap, said primary end of said second strap being extendable through said second buckle for adjusting a length of said second strap;
a third strap being coupled around each of said poles wherein said third strap is configured to be extended over the object being carried for securing the object on said poles, said third strap extending around each of said third sleeves, said ridges on each of said third sleeves inhibiting said third strap from sliding off of said third sleeves, said third strap having a primary end and a secondary end; and
a third buckle being coupled to said secondary end of said third strap, said primary end of said third strap being extendable through said third buckle for adjusting a length of said third strap.
